(19) United States
(12) Patent Application Publication
(10) Pub. No.: US 2019/0217893 A1
(43) Pub. Date: Jul. 18, 2019

(54) ELECTRIC VEHICLE COMPRISING A CROSS MEMBER FOR INCREASING LATERAL MOVEMENT

(71) Applicant: GM GLOBAL TECHNOLOGY OPERATIONS LLC, Detroit, MI (US)

(72) Inventors: Bhushan W. Dandekar, ROCHESTER HILLS (US); Wonhee Lee, Seoul (KR); Dongyeol Yoo, Buheung-ro, Bupyeong-gu (KR); Sungjoon Oh, Seoul (KR); Junhyeok Kang, Gimpo-si Pungmu-ro (KR)

(21) Appl. No.: 16/131,178

(22) Filed: Sep. 14, 2018

(30) Foreign Application Priority Data
Jan. 17, 2018 (KR) 10-2018-0005843

(51) Int. Cl. B62D 21/15; B62D 21/03; B62D 25/08; B62D 27/06

(52) U.S. Cl. CPC B62D 21/152; B62D 21/03; B60K 1/00; B62D 27/065; B62D 25/08

(57) ABSTRACT

An electric vehicle is shown. Specifically, an electric vehicle is shown which includes a front frame which forms left and right frame for of the front side of the electric vehicle; fastening part which is located on the inner side of the above front frame; includes a cross member which is connected to the above fastening member so that one side may be able to rotate; and a rotation prevention member which is located at the front part of the above cross member and the above cross member is formed at length toward the width direction of the above vehicle.

### FIELD OF INVENTION

This invention is regarding an electric vehicle, more specifically, an electric vehicle that includes an additional cross member, to increase lateral movement and can reduce damage to the vehicle and harm to the driver.

### BACKGROUND OF THE INVENTION

The structure which absorbs impact when vehicles crash is very important in reducing damage to the vehicle and reduce harm to the driver. Hence, there are continued research and development to improve this structure.

Previously, research and development on structure were focused and performed on a structure that could occur to reduce impact when vehicles are involved on a frontal crash. That is, the research and development were performed while focusing on improving strength of front frame of the vehicle, a method to use additional member, etc. to absorb impact when a frontal crash goes through the process of the front part of the vehicle is denting.

However, there are researches that began on a structure which absorbs impact occurring from a small overlap front crash, other than frontal crash, and reduce damages to the vehicle and harm to the driver. This is because vehicles that are designed for frontal crash is lacking in structural performance for crash from small overlap front.

Especially, if vehicles are involved in a small overlap front crash, an amount of impact that is applied on one side must transfer the amount of impact to the other side to amplify lateral movement of the vehicle and reduce the amount of deformation to the passenger room of the vehicle, and may improve the safety of the driver.

Vehicles that use the existing internal-combustion engine, transfers the amount of impact to the other side using the engine and transmission that are located inside the engine room, but electric vehicle has a small driving unit without the engine in the front part of vehicle inside the engine room, thus a transfer of the amount of impact via the driving unit cannot be achieved.

Korea Registered Patent Document No. 10-0364444 shows the engine mounting installation structure which prevents the engine from being pushed back in a frontal crash via an engine mounting structure that is equipped with an additional buffer member inside the engine room.

However, this type of roll mounting structure for vehicle engine, etc. may apply for internal combustion engine, etc. in which the engine is big in size and volume but has the limitation which cannot be applied to electric vehicle that has a driving unit small in size and volume.

Korea Registered Patent Document No. 10-0968739 shows a roll mounting structure for vehicle engine that would reduce the vehicle deformity on the bottom part of the dash by inducing buckling and sliding of engine roll mounting bracket in case of frontal eccentric cash.

However, this type of roll mounting structure for the vehicle engine may be applied when the size and volume of the engine such as internal combustion engine is large, but there is a limitation because it cannot be applied to an electric vehicle equipped with a driving unit that is small in size and volume.

The purpose of this invention is to provide an electric vehicle which can improve safety of the driver by reducing the amount of deformation of passenger room in the vehicle by amplifying a lateral movement of the vehicle in case of a small overlap front crash for electric vehicle which is equipped with small driving unit.

### SUMMARY OF THE INVENTION

To achieve the above purpose, this invention, provides an electric car including a front frame (400) which forms a frame for both left and right side of the front side of the electric car; a fastening part (300) which is located internally to the above front frame (400); a cross member (100) that is connected to the above fastening part (300) so that one side can rotate; and includes a rotation prevention member (200) which is located on small overlap front side of the front side of the above cross member (100) and the above cross member (100) is formed on the width direction of the above vehicle.

Also, the above rotation prevention member (200) may be a right angle triangle shape.

Moreover, the above fastening part (300) includes a fastening member (310) which is located inside the above front frame (400), and the above fastening member (310) may include a fastening hole (320) which a bolt (340) penetrates; and a discharge outlet part (330) which extends from the above fastening hole(320).

Moreover, if the above electric vehicle collides head-on the above front frame (400) gets buckled, and due to the above rotation prevention member (200), one side of the above cross member (100) may be prevented of the rotation to the front side.

According to this invention, if a vehicle is involved in a small overlap front crash, an impact is transferred to the other side because of the cross member, and the lateral direction movement is amplified for the vehicle, and the amount of deformation for the passenger room in the vehicle is reduced and improves the safety of the driver.

Moreover, if a vehicle is involved in a frontal crash, the cross member is discharged from the front frame because of the rotation prevention member, an impact energy may be absorbed by the buckling of the front frame and the safety of the driver will be improved.

### BRIEF DESCRIPTION OF THE DRAWINGS

FIG. 1 is a drawing which schematizes a cross member fastened according to the embodiment of the invention.

FIG. 2 is a drawing which schematizes the combination relationship for the cross member of FIG. 1 and the front frame.

FIG. 3A is a drawing which schematizes an electric vehicle that includes a cross member of FIG. 1 that shows the vehicle before a frontal crash.

FIG. 3B is a drawing which schematizes an electric vehicle that includes a cross member of FIG. 1 that shows the vehicle after a frontal crash.

FIG. 4 is a drawing which roughly schematizes the change process for the cross member and the front rail when an electric vehicle is involved in a frontal crash.

FIG. 5A is a drawing which shows a cross member of an electric vehicle prior to involvement in a frontal crash.

FIG. 5B is a drawing which shows a cross member of an electric vehicle breaking away from the front frame after the vehicle is involved in a frontal crash.

FIG. 6A is a drawing which schematizes an image of an electric vehicle that includes a cross member for FIG. 1 before a small overlap front crash.

FIG. 6B is a drawing which schematizes an image of an electric vehicle that includes a cross member for FIG. 1 after a small overlap front crash.

FIG. 7 is a drawing which schematizes an image that roughly shows a small overlap front crash of an electric vehicle in FIG. 6.

FIG. 8A is a drawing which schematizes an image of the electric vehicle shown in FIG. 6 prior to a crash.

FIG. 8B is a drawing which schematizes an image of the electric vehicle shown in FIG. 6 after a crash that shows that the cross member does not rotate after the crash.

FIG. 9 is a graph that schematizes an image that an electric vehicle that includes cross member of FIG. 1 collides on small overlap front and is amplified of lateral movement.

### DETAILED DESCRIPTION OF THE INVENTION

Below, while referring to the attached Figures, we will explain in detail about the electric vehicle that includes the cross member in embodiment of this invention.

The terms used below, “front side”, “back side”, “left side”, “right side” are defined as the following; “front side” is a direction where the driver looks when the driver is seated in the driving seat; back side” is the direction behind of the vehicle; “left side” is the left direction of the driver; and “right side” is the right direction of the driver.

Moreover, the term “full frontal crash” is defined as a frontal crash which the vehicle collides with the obstacle on the front of the vehicle.

Moreover, the term “offset frontal crash” is defined as when the frontal part of the vehicle that is 40% of the length toward the lateral direction from the middle direction to the left or right end crashes with the obstacle on the front of the vehicle.

Moreover, the term “frontal crash” is defined to include the described full frontal crash and offset frontal crash.

Moreover, the term “shallow offset frontal crash” is when the front of the vehicle that is 25% of the length toward the lateral direction from the left or right end of the vehicle crashes with the obstacle on the front of the vehicle.

Moreover, the term “Small overlap front crash” is defined to refer to the described shallow offset frontal crash.

Below, while referring to the attached Figures, it describes in detail, an electric vehicle which includes a cross member (100) in accordance with the embodiment of this invention.

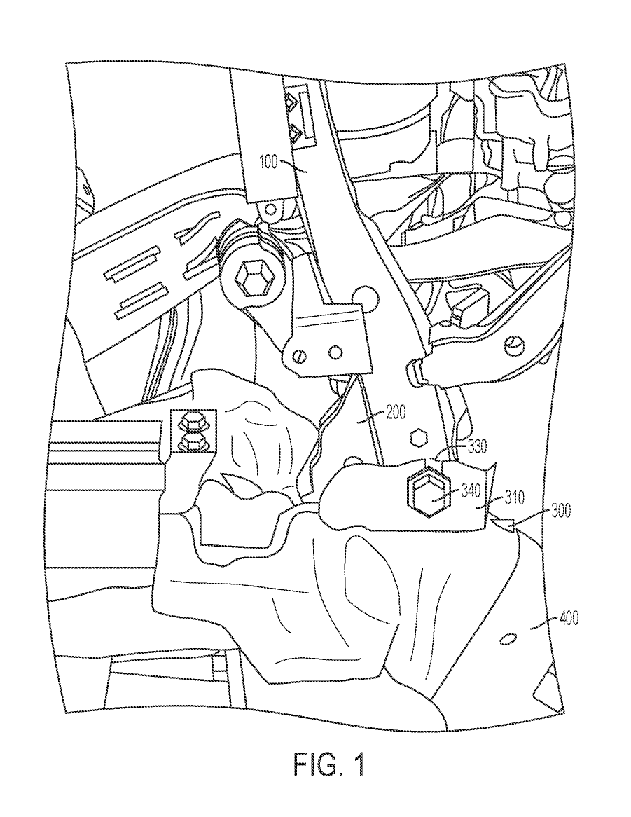

Referring to the FIG. 1 to FIG. 3, the electric vehicle according to the embodiment of this invention includes cross member (100), rotation prevention member (200), fastening part (300), front rail(400), hardness strengthening member (500), No.1 frame part(600), driving unit (700), and No. 2 Frame part (800).

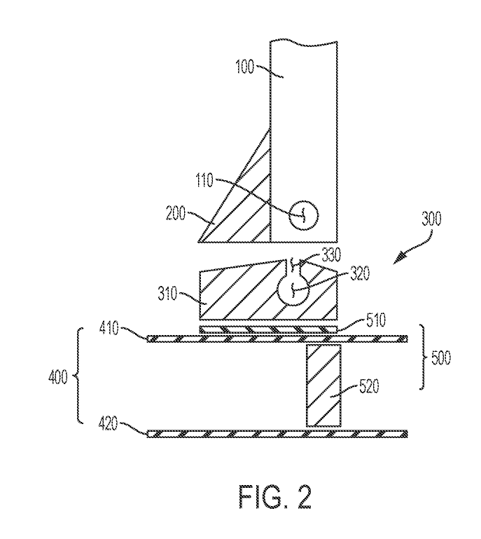

Referring to FIG. 1 and FIG. 2, the electric vehicle that is according to the embodiment of this invention includes a cross member (100)

If the vehicle is involved in a frontal crash or a small overlap front crash, the amount of impact transferred to the other side of the vehicle. On the schematized embodiment, the cross member (100) is equipped on a bar type form but the shape of the cross member (100) may be changed.

The cross member (100) shall be properly equipped in a material with hardness. That is, if the cross member (100) bends during the process that transfers the amount of impact, only a part of the impact amount may be transferred.

In the front part of the cross member (100), a rotation prevention member (200) which shall be described later, is combined, and the cross member (100) does not rotate on a frontal crash, and may be discharged from the fastening part (300) which will be described later. Alternatively, the other side of the cross member (100) may be fastened to the front rail(400) which shall be described later via the fastening part (300) which will be described later, and both sides of the cross member (100) may be fastened on the front rail (400).

The cross member (100) includes the fastening hole member (110).

The member fastening hole (110) may be formed while penetrating so that the cross member (100) may be fastened to the fastening part (300) which shall be described later.

On the schematized embodiment, the member fastening hole (110) is equipped as a penetrating hole near the end of one side for the cross member (100).

The member fastening hole (110) is penetrated and inserted with the bolt (340) which will be described later, and is combined with cross member (100) and the fastening part (300).

Referring the FIG. 1 and FIG. 2, electric vehicle which is according to the embodiment of this invention includes the rotation prevention member (200).

Rotation prevention member (200) is equipped on the frontal part of the cross member (100) and prevents the rotation of a cross member (100) if the vehicle is involved in a small overlap front. For such, the rotation prevention member (200) is located so that it would adhere to the small overlap front part of the cross member (100) and inner part of the front rail (400) which will be described later.

To prevent rotation of cross member (100) during the crash of the vehicle, the rotation prevention member (200) is to be properly formed using a material with sufficient hardness.

In the embodiment schematized, the bottom part of the rotation prevention member (200) shall adhere to the front rail (400) which will be described later, and the side is in a right triangle shape that adheres to the frontal part of the cross member (100) but the shape may be changed.

On the schematized embodiment, the rotation prevention member (200) shall be equipped on one side which the cross member (100) is fastened to the fastening part (300). Alternatively, the rotation prevention member (200) may be equipped on the other side of the cross member (100) and it may be equipped on both side of the cross member (100).

Referring to FIG. 1 and FIG. 2, the electric vehicle according to the embodiment of this invention includes the fastening part (300).

Fastening part (300) fastens the rotation prevention member (200) that is combined with the cross member (100) and cross member (100) with the front rail (400) which will be described later.

On the schematized embodiment, the fastening part (300) is located while adhering to the inner side (410) of the front rail (400) and the direction of the front side and the back side may be changed according to the design.

On the schematized embodiment, the fastening part (300) is equipped to the front rail (400) which is near one side of the cross member. Alternatively, a front rail (400) which is near the other side or both sides of the cross member (100) may be equipped to the fastening part (300).

Fastening part (300) includes the fastening member (310), fastening hole (320), discharge outlet (330) and a bolt (340)

Fastening member (310) forms a body on the fastening part (300) and is located while adhering to the inner side (410) of the front rail (400) that will be described later. It is proper that the side which is adhering to the fastening member (310) and front rail (400) which will be described later.

Fastening member (310) is inserted of a cross member (100) and is fastened with a cross member (100) and a fastening member (310) via a bolt (340).

Fastening member (310) is formed of a fastening hole (320) and a discharge outlet (330).

For a fastening hole, when the cross member (100) is inserted to the fastening member (310), member fastening hole (110) for the cross member (100) and a bolt (340) which will be described later are inserted together and shall be combined with the cross member (100) and the fastening part (300).

In the schematized embodiment, the fastening hole (320) may be formed in a cylinder shape or other different shapes.

However, a fastening hole (320) shall be properly formed if the cross member (100) is inserted to fastening member (310) for combination , so that it would locate in harmony with the member fastening hole (110) for the cross member (100).

The discharge outlet (330) forms a passage where the cross member (100) may discharge to the external side of the fastening part (300) in case a frontal crash for the vehicle occurs.

On the schematized embodiment, a discharge outlet (330) is formed on the upper side of the fastening hole (320) while penetrating, but the location may be changed.

The width of the discharge outlet (330) may be changed. However, as it will be described later, to allow easy discharge of cross member (100) in case of frontal crash of the vehicle, it is proper that it would be greater or equal to the diameter of the bolt (340) which will be described later.

The process which the cross member (100) discharges in case of frontal crash of the vehicle will be described later.

For a bolt (340), if a cross member (100) is inserted to the fastening part (300), it penetrates and combines it to the fastening hole (320) and member fastening hole (110) and combines the cross member (100) with the fastening part (300).

A bolt (340) may be equipped as other member that could combine the cross member (100) and the fastening part (300).

Referring to FIG. 1 and FIG. 2, the electric vehicle according to the embodiment of this invention includes a front rail (400).

Front rail (400) forms a frame on both left and right side of the front of the vehicle. For such, front rail (400) is equipped on multiple numbers on left and right end of the vehicle structure.

On the schematized embodiment, a front rail (400) is in the shape of polyprism that includes an internal space but the shape of front rail (400) may be changed.

In the internal or external side of the front rail (400), a hardness strengthening member (500) may be located to improve strength of the front rail (400).

Front rail (400) is proper if formed with a material that has sufficient hardness. However, a certain level of buckling is needed for front rail (400) to absorb impact in case of frontal crash or small overlap front crashes of the vehicle.

A description on the vehicle crash and the buckling process for the front rail (400) will be described later.

Front rail (400) includes the inner side (410) and external side (420).

Inner side (410) is a side which the front rail (400) faces the inner side of the vehicle.

Inner side (410) is combined with hardness strengthening member (510) and the fastening part (300) which will be described later.

The external side (420) is on an opposing side of the inner side (410) and is a side which faces the external side between both sides of the frontal rail (400).

On a space which is created by a separation between the external side (420) and the internal side (410), a hardness strengthening member (520) is located which will be described later, and strengthens the hardness of frontal rail (400).

Referring to FIG. 1 and FIG. 2, the electric vehicle that is according to the embodiment of this invention includes the hardness strengthening member (500).

Hardness strengthening member (500) is located on the external and internal side of the front rail (400) to strengthen the hardness of the front rail. Because of hardness strengthening member (500) buckling of front rail (400) may be prevented under equal or less than the standard impact amount.

Hardness strengthening member (500) includes the No.1 hardness strengthening member (510) and No.2 hardness strengthening member (520).

No.1 hardness strengthening member (510) is located between the inner side (410) of the front rail (400) and fastening part (400), and strengthens the hardness of front rail (400). Moreover, it could achieve an effect to strengthen hardness of the fastening part (300).

From the schematized embodiment, No.1 hardness strengthening member (510) is equipped as a plate type member but the shape of the No1. Hardness strengthening member (510) may be altered in shape.

No.2 hardness strengthening member (520) is located in the inner side of the front rail (400) and strengthens the hardness of the front rail (400).

From the schematized embodiment, No.2 hardness strengthening member (520) may be equipped with a polygon three-dimensional shape, but the shape of the No.2 hardness strengthening member (520) may be altered.

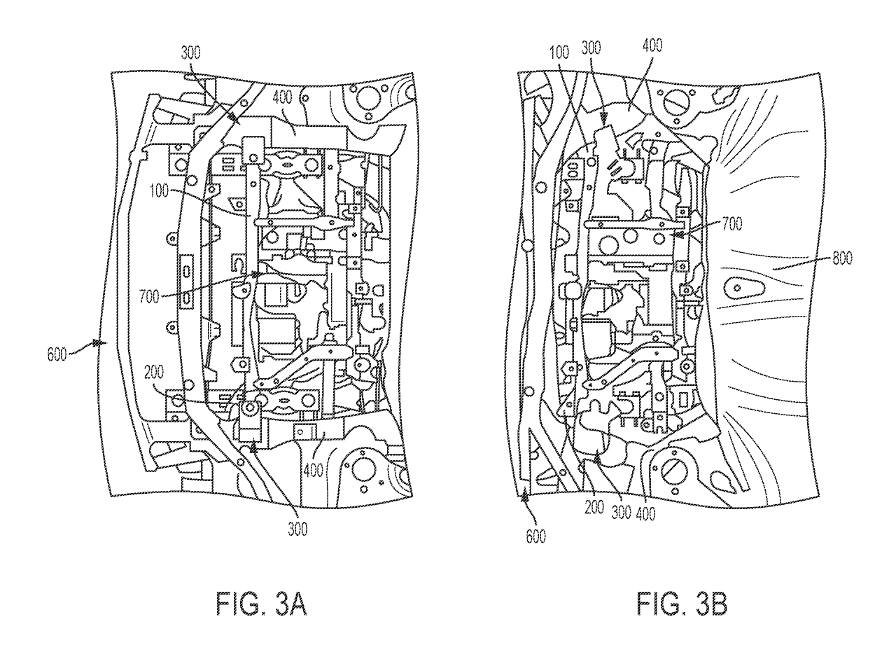

Referring to FIG. 3, the electric vehicle according to the embodiment of this invention includes a No.1 frame part (600).

From the schematized embodiment, No.1 frame part (600) is located on the frontal side of the vehicle and if the frontal crash or small overlap front crash is progressed, it is buckled to the rear side of the vehicle and during this process, an amount of impact to the vehicle is absorbed.

It is appropriate for the No.1 frame part (600) to be formed using a material with sufficient hardness.

Referring to the FIG. 3, the electric vehicle according to the embodiment of this invention includes the driving unit (700).

The driving unit (700) accommodates various driving part(non-drawn), and control part (non-drawn), etc.

Because the equipped driving unit (700) is smaller compared to the existing internal combustion engine vehicle, it is difficult to transfer the amount of impact to other side when a small overlap front crash occurs, and that is why a transfer of amount of impact via cross member (100) of the embodiment of this invention is progressed. The description of such shall be described later.

Because the structure and the function of driving unit (700) are a well-known technology, additional description shall be omitted.

Referring to FIG. 3, the electric vehicle according to the embodiment of this invention includes a No.2 Frame Part (800).

From the schematized embodiment, No.2 frame part (600) is located on the rear side of the driving unit (700) and absorbs the amount of impact if a vehicle is involved in a frontal crash or small overlap front crash, and limits the distance of the vehicle buckling toward the rear side and minimizes the deformation of the vehicle passenger room and improves the safety of the driver, accordingly.

It is appropriate to form the No.2 frame part (800) with a material with sufficient hardness.

Electric vehicle according to the embodiment of this invention transfers the amount of impact that is imposed on one frontal side of the vehicle via cross member (100), and amplifies the lateral movement of the vehicle and minimizes the amount of deformation of vehicle passenger room and improves the safety of the driver.

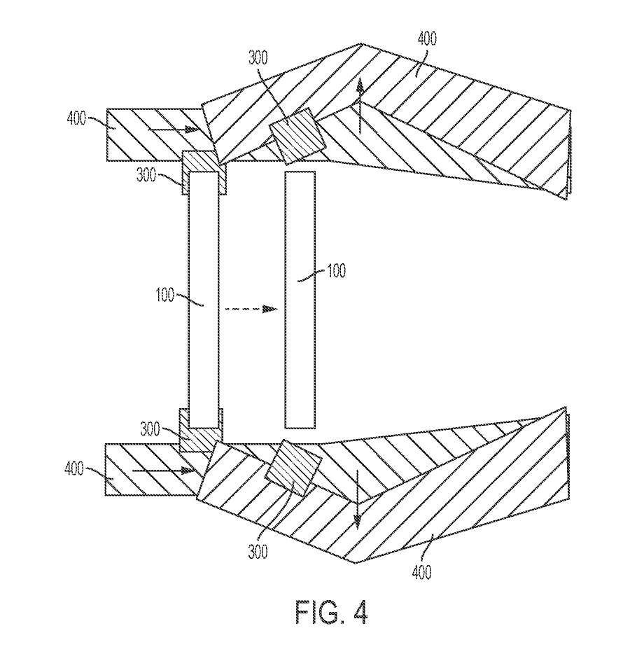

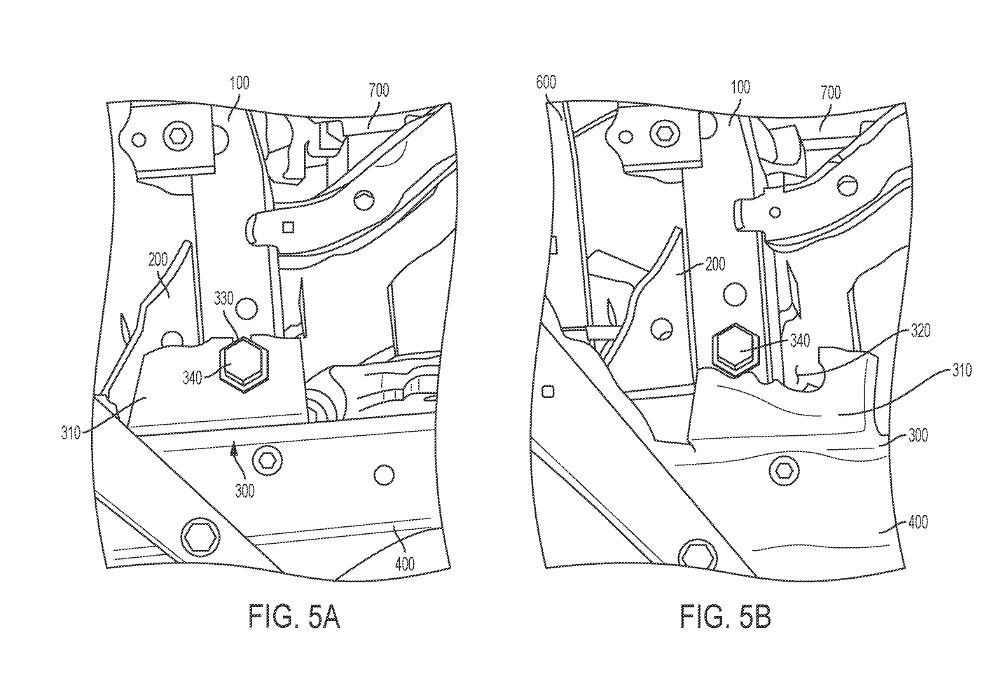

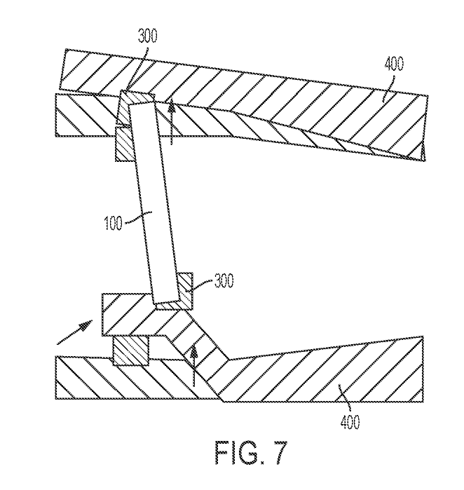

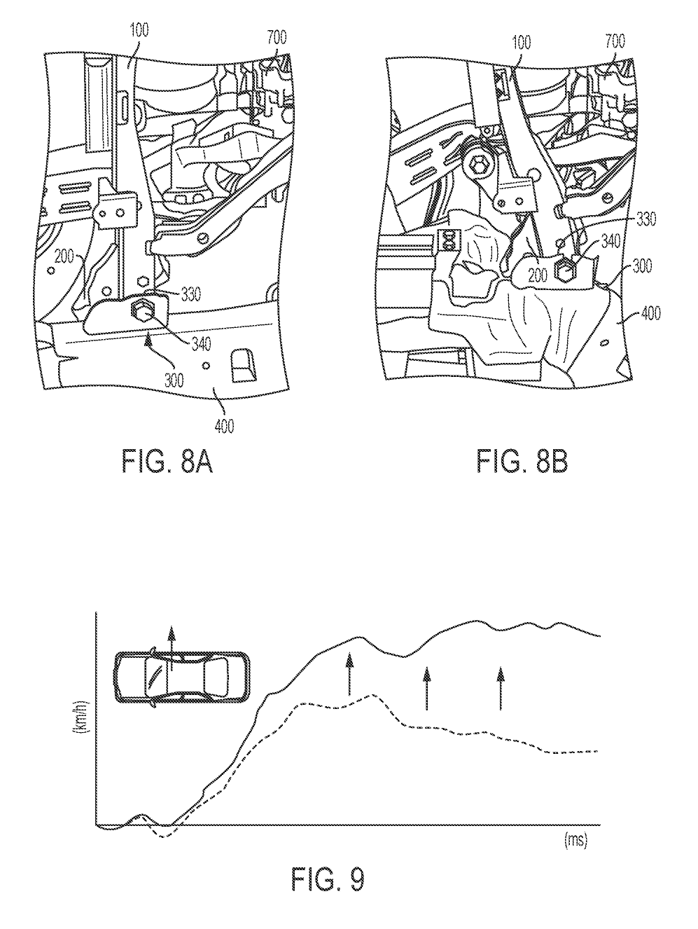

Below, referring to FIGS. 3 to 9, electric vehicle according to the embodiment of this vehicle describes in detail a process in which a vehicle crashes and the lateral movement of the vehicle increases.

Referring to the FIGS. 3 to 5, a vehicle for the schematized vehicle schematizes the situation before and after the frontal crash.

If a vehicle is involved in a frontal crash, the front a buckling toward the external direction of the vehicle occurs for the front rail (400) which is located on left and right side of the vehicle.

In this case, the amount of impact imposed on the vehicle is consumed for the buckling of the front rail (400) and the amount of impact reduces as it goes toward the rear direction of the vehicle.

In this case, if a cross member (100) exists while connected to the fastening part (300), the direction which the cross front member (100) pulls the front rail (400) is an internal direction of the vehicle which is opposed to the direction of buckling for the front rail (400)

Accordingly, to reduce the amount of impact that is affecting the rear side of the vehicle via buckling of the front rail (400), cross member (100) shall be discharged from the fastening part (300).

As a buckling occurs for front rail (400) toward the external direction of the vehicle occurs, cross member (100) is separated via discharge outlet part (330) created at the upper side of the fastening hole (320) from the fastening par (300).

As described above, member fastening hole for cross member (100) and the fastening hole (320) of the fastening part (300) is fastened via a bolt (340) but it is created such that the discharge outlet part has the width which exceeds the diameter of the bolt (340) so bolt (340) may be separated from the fastening member (310) via discharge outlet part (330)

Accordingly, because the buckling process of front rail (400) may easily be progressed because the cross member discharges from the fastening part (300) in case of front crash of a vehicle, the amount of deformation for the vehicle passenger room may be reduced due to absorption of impact from buckling.

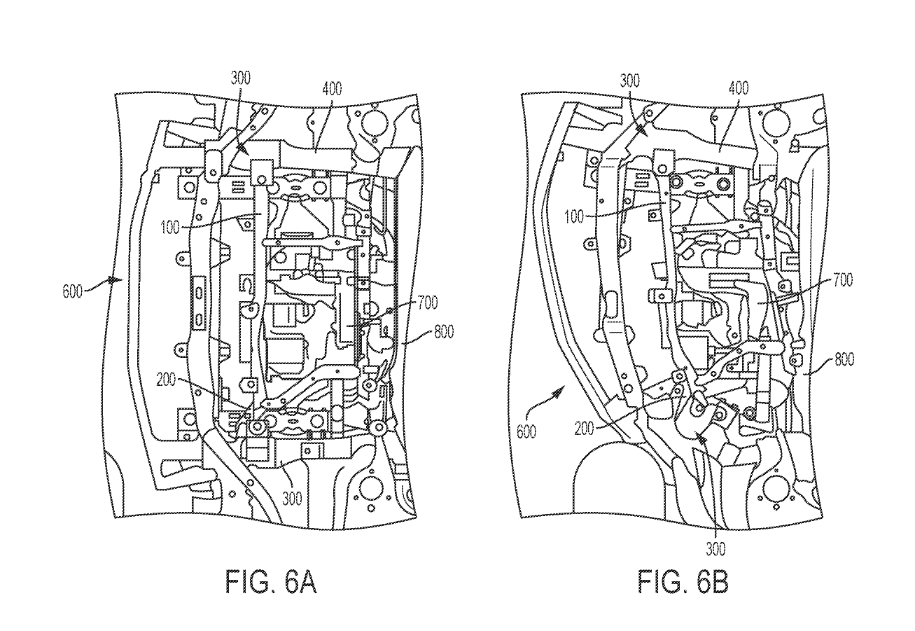

Referring to FIGS. 6 to 8, a vehicle according to the schematized embodiment, schematizes a situation before and after the small overlap front crash.

If a vehicle is involved in a small overlap front crash, unlike the frontal crash, one side of the front side (hereinafter shall be referred to as “impact side”) is focused with the impact amount and the buckling occurs mainly on front rail (400)

In this case, unlike the front crash, only a buckling on the front rail (400) for the impact side occurs, and relatively small amount among the amount of impact occurred due to crash is used for buckling, and there is a concern that the amount of impact will be transferred to the passenger room.

Accordingly, the amount of crash imposed on the front rail (400) needs to be transferred to the front rail (400) on the other side, and that is performed by a cross member (100) which is combined with inner side (410) of the front rail (400) on the impact side.

In this case, because the front rail (400) on the impact side is buckled toward the inner side of the vehicle, cross member (100) shows a tendency to rotate toward the counter-clock direction as fastening hole (320) of the fastening part (300) as its axis.

Of course, if the location of the impact side changes to the opposite, cross member (100) will show a tendency to rotate toward the clockwise direction as fastening hole (320) of the fastening part (300) as its axis.

If cross member rotates, amount of impact imposed on the front rail (400) of the impact side cannot be transferred to the other side of front rail (400).

In this case, rotation prevention member (200) which is located on the front side of the cross member (100) prevents rotation of cross member (200).

Specifically, if the cross member (100) on the impact side tries to rotate counter-clockwise direction with fastening hole (320) as its axis, the cross member (100) does not rotate because of repulsive force from inner side (410) of front rail (400) and the rotation prevention member (200).

Accordingly, the amount of impact imposed on the front rail (400) of the impact side is distributed to the front rail (400) on the other side via cross member (100), the level of buckling for front rail (400) on the impact side is reduced and the amount of impact transferred to the passenger room is also reduced.

Due to the impact, a cross member (100), will show a tendency wherein one side that is fastened with the fastening hole (320) will be pushed toward the rear side, and the other side will show a tendency to rotate toward the front side with a fastening hole (320) as its axis; the rotation prevention member (200) is located on the front side of the cross member (100) of each side, and in any case, the rotation of cross member (100) is prevented.

Referring to FIG. 9, if the electric vehicle which is equipped with the cross member (100) according to the embodiment of this invention is involved in a frontal crash with an electric vehicle not equipped with such, you may acknowledge the difference of the speed of movement toward the lateral direction.

A graph schematized with a line is a movement speed toward the lateral direction for an electric vehicle equipped with the cross member (100) according to the embodiment of this invention and the graph schematized with a line shows a movement speed toward the lateral direction for an electric vehicle not equipped with such.

If you look at the movement speed toward the lateral direction, you can see that it initially shows a similar speed. That could be understood as the movement speed toward the lateral direction during the time when buckling is occurring on the front rail (400) on the impact side.

After a small amount of time has passed, the movement speed toward the lateral direction shows big difference and this is because for an electric vehicle equipped with the cross member (100) according to the embodiment of this invention, an amount of impact is transferred via cross member (100) and the front rail (400) on the other side also started the buckling.

On the other hand, for an electric vehicle which is not equipped with cross member (100), the speed which the amount of impact is transferred to the front rail (400) on the other side is slow; it could be understood as that the speed and the level of buckling for the front rail (400) on the other side is low.

That is, an electric vehicle equipped with the cross member (100) according to the embodiment of this invention can quickly transfer more impact toward front rail(400) of other side that is transferred to the front rail (400) on the impact side, even when small overlap crash occurs.

Accordingly, because the amount of impact that is imposed on one side because of small overlap crash, the movement toward the lateral direction for a vehicle is amplified and this could reduce the amount of deformation for the passenger room, and this could improve safety of the passenger.

As such, we have explained while referring to the proper embodiment of this invention, but a personal with normal knowledge of this industry may understand that he or she may alter and change this invention in various ways while not deviating from the idea and area of this invention which is described on the following scope of claim.

### DESCRIPTION OF DRAWING ELEMENTS

100: Cross member

110: Member fastening hole

200: rotation prevention member

300: fastening part

310: fastening member

320: fastening hole

330: discharge outlet part

340: bolt

400: front rail

410: inner side

420: external side

500: hardness strengthening member

510: No.1 hardness strengthening member

520: No.2 hardness strengthening member

600: No.1 frame part

700: Driving unit

800: No.2 frame part

What is claimed is:

1. An electric vehicle which comprises a front frame which forms a frame on the front of the electric vehicle both sides on left and right;
a fastening part which the above front frame is located on the inner side;
a cross member which connects to the above fastening part on one side which makes it rotation-able; and includes a rotation prevention member which is located on the front side of the above cross member, and the above cross member) is formed at length on the width direction of the above vehicle.

2. The electric vehicle of claim 1 wherein the above rotation prevention member is shaped as right triangle.

3. The electric vehicle of claim 2 wherein the above fastening part includes the fastening part which is located on the inner side of the above front frame, the above fastening member, includes a fastening hole which a bolt penetrates; and includes a discharge outlet part which extends from the above fastening hole.

4. The electric vehicle of claim 3 wherein if the above electric vehicle is involved in a small overlap frontal crash the above front frame is buckled, and one side of the above cross member is discharged to the front side of the vehicle due to the above discharge outlet part.

5. The electric vehicle of claim 3 wherein if the above electric vehicle is involved in a small overlap frontal crash the above front frame is buckled, and one side of the above cross member is prevented of a rotation to the front side due to the above rotation prevention member.
